(19) United States
(12) Patent Application Publication
(10) Pub. No.: US 2008/0024952 A1
(43) Pub. Date: Jan. 31, 2008

(54) System for removing energy from tornados and hurricanes

(76) Inventor: Robert W. Beckwith, Clearwater, FL (US)

Correspondence Address: Leo J. Aubel, 111 Rivershire Lane, Lincolnshire, IL, 60069, US

(21) Appl. No.: 11/485,916

(22) Filed: Jul. 13, 2006

(51) Int. Cl. H05F 3/00

(52) U.S. Cl. 361/231; 239/2.1; 361/212

(57) ABSTRACT

A system and method for removing energy from tornados and hurricanes whereby the formation of a tornado is prevented or the force of the tornado or hurricane is substantially decreased. The system comprises superconducting donuts not requiring cryogenic cooling for producing magnetic fields, high permeability posts mounted on the ground in positions at the center of the donuts for developing artificial lightning that can be directed toward the tornado or adjacent clouds to remove energy from the tornado or hurricane.

### REFERENCES:

1. patent application Ser. No. 11/476,248: SUPERCONDUCTING CARBON 12 ATOMIC STRINGS AND METHODS OF MANUFACTURE OF CABLES CONTAINING PARALLEL STRINGS.

2. patent application Ser. No. 11/476,248: A NEUTRINO TELESCOPE

Reference patent applications 1 and 2 are to be considered contained herein in their entirety.

### SUMMARY

In a first application the inventive system is capable of extracting energy from clouds about to form tornados and prevent their forming. In a second application the inventive system is capable of extracting energy from hurricanes and reducing their intensity.

Computer modeling is extensively used, especially at the University of Oklahoma, to understand the mechanism for formation of tornados. Once this application has been filed we will ask the University of Oklahoma study team to find if a point of energy extraction can be determined that will disrupt tornado formation.

Other computer programs are being used to model hurricanes and can be used to study the reduction of hurricane force by some number of energy extracting points.

The inventive energy extracting system uses a donut shaped ring of carbon superconductors with about a square foot cross section. The donut is mounted slightly above ground level with a high permeability rod at its center pointed to the sky. When carrying maximum current it is expected that a continuous lightning arc can be directed into clouds.

For fighting tornados it may be possible to mount the entire system on a flat bed truck. With help from friends at the National Security Agency (NSA) it may be possible to instantly teleport systems to spots on the ground marked by GPS transponders.

Information to and from the systems is sent by frequency shift coded signals over a neutrino telescope for security and for freedom from emf interference.

A brief description of the Figures:

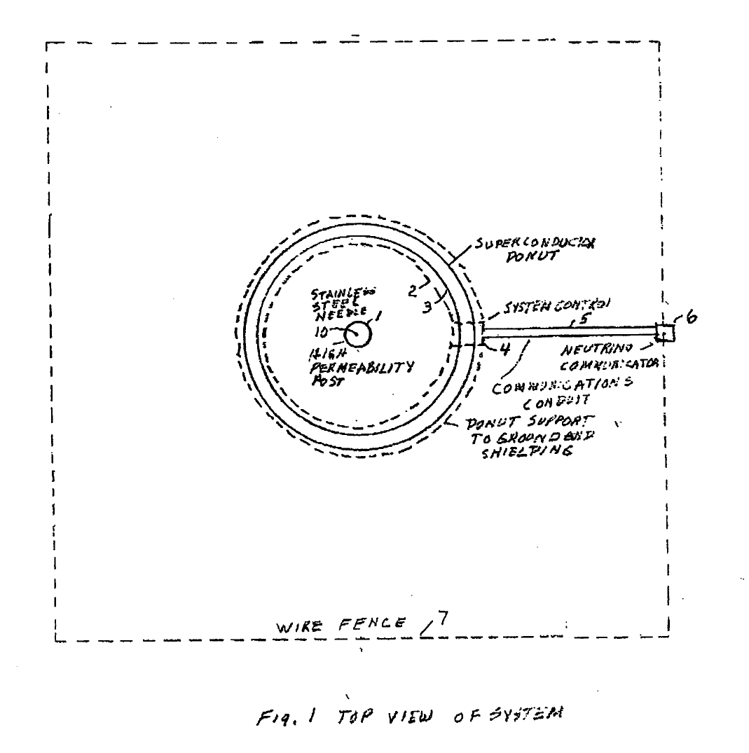

FIG. 1 shows a top view of a superconducting donut mounted on the ground with a high permeability bar mounted in the earth in the center of the donut and extended upward into the sky.

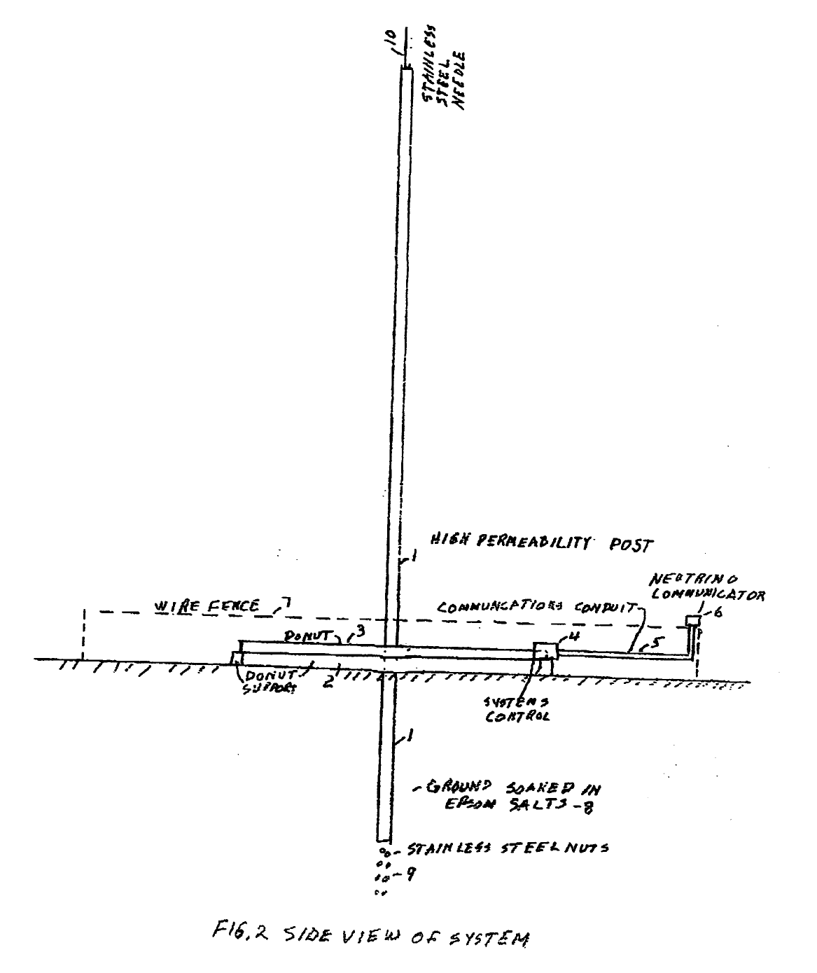

FIG. 2 shows a side view of FIG. 1.

### A DETAILED DESCRIPTION OF THE PREFERRED EMBODIMENT

I, Robert W. Beckwith, the present inventor herein, will personally write this patent application in the first person. The invention is based on natural behavior of storms which can best be described from experience and not as absolute fact.

FIG. 1 shows a top view of the inventive system. The system creates artificial lightning into clouds as the result of high magnetic fields created by high currents in a donut that contains carbon superconductors that need no cryogenic cooling. The superconducting donut 3 is mounted far enough above ground on support and shield 2 to be above any water that might stand on the ground after a rain. The high permeability post 1 is positioned at the center of donut 3. When the systems is operating, control 4 furnishes high currents to donut 3 producing very high magnetic fields which are enhanced by high permeability post 1. Post 1 has a stainless steel needle at its top therefore increasing the voltage gradient at the point of the needle for inducing artificial lightning currents into clouds above the system. Donut shield 2 protects donut 3 from damage from incidental sparks that may be caused by operation of the system.

Communications to the system is via a neutrino communications channel terminal 6 to a remote point out of danger from the artificial lightning created when the system is operating. Information is communicated by frequency shift keying of neutrino telescope exciting currents as described in more detail under reference 2 patent application Ser. No. 11/476,248. Communications from system control 4 to neutrino communicator 6 is via communications conduit 5.

Wire fence 7 keeps humans and critters from getting inside of the lightning generator system. Fence 7 also provides a mount for neutrino terminal 6.

FIG. 2 shows a side view of the inventive system. Donut 3 is mounted above any standing water on a donut case 2 that shields the donut from damage by the artificial lightning generated by the system when active.

Post 1 is supported by a hole in the ground. The bottom of the hole is provided a low impedance ground by soaking the ground with epsom salts 8 and a sprinkling of stainless steel nuts 9 in the ground under post 1.

I have found that epsom salts and stainless steel nuts can provide an ground impedance of less than 100 ohms.

For fighting tornados the system can be mounted on a movable platform. With help from friends at NSA it may be possible to teleport such stations to where they are needed to either prevent a tornado possibly to stop a tornado already formed. Perhaps GPS transponders can be mounted at various ground locations where a system may be needed.

It is necessary to experiment with actual storms to know the degree of tornado protection that can be accomplished.

I have many items concerning weather that are not rigorous yet are useful in bring the inventive system to the point that tornados can be prevented. I believe that clouds about to form tornados have lightning from ground to cloud but not cloud to ground. Artificial lightning from ground to cloud may take energy from the clouds and not permit tornados to form. An article on a NOVA television programmed showed the work going on in computer modeling of storms. Some have produced the vortices known to exist before tornados form. As soon as this patent application is submitted I will contact the University of Oklahoma and other institutions reported to be working on computer modeling. I believe that they will be quite willing to cooperate with our system design. Perhaps I can obtain a copy of a program to permit my colleagues and me to best locate spots where energy extraction will be effective.

Another problem to be solved is where to obtain the superconducting donut and control. Here are several possibilities:

1. Intermarine SpA of La Spezia Italy as suggested on page 22, line 15 of reference 1 patent application Ser. No. 11/476,246.

2. Ansaldo Superconduttori Gruppo Malacalza/Magnets/Superconductive and resistive magnets

3. National Security Agency

Advantages of the invention:

1. Providing a lightning generator improved over Teslas' in Colorado Springs circa 1885.

2. Possibly develop technology to prevent tornado formation.

3. Provide means for reducing the intensity of hurricanes.

1. Apparatus for preventing formation of tornados comprising the following in combination:
a) superconducting donut means for producing magnetic fields,
b) high permeability post means for concentrating magnetic fields),
c) mounting means for combining said donut means and said post means for placing said donut means on the ground with said post means held at the center of said donut means, and
d) system control means for placing maximum acceptable currents in said superconducting donuts
whereby artificial lightning is produced upwards from said apparatus.

2. A method for preventing tornados comprising the steps of:
a) using superconducting donuts for producing strong magnetic fields,
b) using high permeability posts for concentrating said strong magnetic fields,
c) placing said donuts on the ground with said posts pointing from the center of said donuts upward towards the sky,
d) pointing said posts at selected points in storm clouds capable of forming tornados, and
e) providing currents for said superconducting donuts for projecting artificial lightning at said selected points in storm clouds whereby the formation of tornados is prevented.
